(19) United States
(12) Patent Application Publication
(10) Pub. No.: US 2011/0055204 A1
(43) Pub. Date: Mar. 3, 2011

(54) Method and apparatus for content tagging in portable terminal

(75) Inventor: Jae-Hee Jung, Suwon-si (KR)

(73) Assignee: SAMSUNG ELECTRONICS CO., LTD., Suwon-si (KR)

(21) Appl. No.: 12/807,270

(22) Filed: Sep. 1, 2010

(30) Foreign Application Priority Data
Sep. 2, 2009 (KR) 10-2009-0082264

(51) Int. Cl. G06F 17/30

(52) U.S. Cl. 707/722; 707/769; 707/E17.014

(57) ABSTRACT

Content tagging method and apparatus automatically tag points of interest in a portable terminal. The content tagging method in the portable terminal includes determining a search region using current location information when creating content; and searching a Point of Interest (POI) corresponding to the search region from a pre-stored POI list. The searched POI is tagged to the content.

### CROSS-REFERENCE TO RELATED APPLICATION(S) AND CLAIM OF PRIORITY

The present application is related to and claims the benefit of priority under 35 U.S.C. §119(a) to a Korean patent application filed in the Korean Intellectual Property Office on Sep. 2, 2009, and assigned Serial No. 10-2009-0082264, the entire disclosure of which is hereby incorporated by reference.

### TECHNICAL FIELD OF THE INVENTION

The present invention relates generally to a method and an apparatus for content tagging in a portable terminal. More particularly, the present invention relates to a method and an apparatus for tagging User Created Content (UCC) using location information.

### BACKGROUND OF THE INVENTION

As services that share User Created Content (UCC) over a web are drawing more and more attention, various schemes are developed and presented to generate and manage the UCC more efficiently.

For example, a method tags a Point of Interest (POI) on the UCC. The method for tagging the POI to the content tags a specific region name or a specific feature name to the content such that the user may easily recognize the region or the feature relating to the content.

In a conventional content creation, a POI within the vicinity is acquired through Radio Frequency Identification (RFID) or a server and tagged to the created content. However, this conventional POI tagging method requires an additional device such as an RFID, and POI tagging is infeasible when the RFID is not attached to the corresponding geographical feature. In addition, the conventional POI method cannot automatically tag the content and the POI, and the user needs to select the POI to tag individually. General tourist attraction POIs and typical POIs may be automatically tagged to the content without reflecting preference and personal information of the individual user.

### SUMMARY OF THE INVENTION

To address the above-discussed deficiencies of the prior art, it is a primary aspect of the present invention to provide a method and an apparatus for tagging content in a portable terminal.

Another aspect of the present invention is to provide a method and an apparatus for automatically tagging a Point of Interest (POI) on a User Created Content (UCC) using location information in a portable terminal.

Yet another aspect of the present invention is to provide a method and an apparatus for determining POI based on speed and direction of a traveling terminal, which are aggregated at a portable terminal, and tagging the POI to a UCC.

Another aspect of the present invention is to provide a method and an apparatus for managing POIs as tourist attraction POI, general POI, and user specific POI and tagging the POIs on a content in a portable terminal.

Another aspect of the present invention is to provide a method and an apparatus for managing preference of POI according to a life pattern of a user and tagging content in a portable terminal.

Another aspect of the present invention is to provide a method and an apparatus for managing POIs selected by a user and tagging as a name of content in a portable terminal.

According to one aspect of the present invention, a content tagging method in a portable terminal includes determining a search region using current location information when creating content and searching a POI corresponding to the search region from a pre-stored POI list. The searched POI is tagged to the content.

According to another aspect of the present invention, a content tagging apparatus in a portable terminal includes a content generator for creating content. A location information receiver periodically obtains location information of the portable terminal. A region determiner determines a search region using the current location information. A storage part stores a POI list, and a POI manager searches a POI corresponding to the search region from the stored POI list and tags the searched POI to the content.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a portable terminal according to an embodiment of the present invention;

FIG. 2 illustrates a method for tagging POI on content in the portable terminal according to an embodiment of the present invention;

FIG. 3 illustrates POI search radii in the portable terminal according to an embodiment of the present invention;

FIG. 4 illustrates a screen configuration to change the tagged POI in the portable terminal according to an embodiment of the present invention;

FIG. 5 illustrates a process for generating a user specific POI in the portable terminal according to an embodiment of the present invention; and

FIG. 6 illustrates a process for managing preference of the POI in the portable terminal according to an embodiment of the present invention.

Throughout the drawings, like reference numerals will be understood to refer to like parts, components and structures.

### DETAILED DESCRIPTION OF THE INVENTION

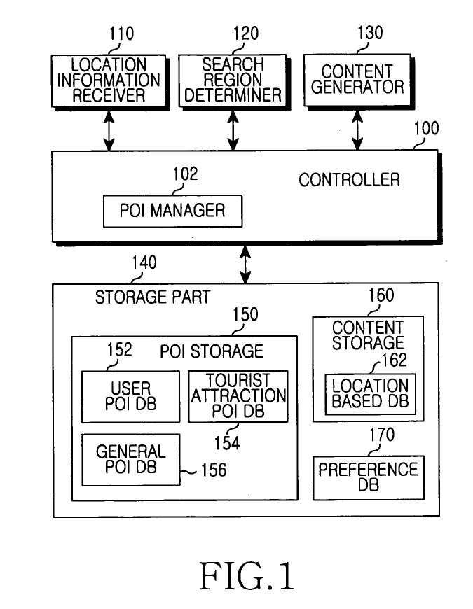

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged portable terminals.

Exemplary embodiments of the present invention provide a method and an apparatus for tagging a Point of Interest (POI) on a User Created Content (UCC) using location information in a portable terminal.

FIG. 1 illustrates a portable terminal according to an embodiment of the present invention.

The portable terminal of FIG. 1 includes a controller 100, a location information receiver 110, a search region determiner 120, a content generator 130, and a storage part 140. The controller 100 includes a POI manager 102. The storage part 140 includes a POI storage 150, a content storage 160, and a preference DB 170.

The controller 100 controls and processes operations of the portable terminal. In particular, the controller 100 includes the POI manager 102 for managing tourist attraction POIs, POIs indicative of geographical features and place names in the vicinity, and POI selected by the user and controlling and processing to automatically tag the POI on a UCC according to location information of the portable terminal.

When the content generator 130 creates the content, the controller 100 receives location information indicating the current location of the portable terminal, i.e. location coordinates from the location information receiver 110, and controls the search region determiner 120 to receive a POI search region according to the location information. Next, the controller 100 searches POIs in the POI search region from POIs stored in the storage part 140, determines one of the searched POIs according to the preset priority and the preset distance, and controls and processes to map the determined POI to the generated content and to store them to the storage part 140. When the POI in the POI search region is absent in the POIs stored to the storage part 140, the controller 100 controls the search region determiner 120 to determine the POI search region by taking into account the speed and the direction of the traveling portable terminal. When the search region determiner 120 provides a re-determined POI search region, the controller 100 searches POIs in the re-determined POI search region among the POIs stored to the storage part 140, and controls and processes to determine one of the searched POIs and to map the determined POI to the generated content. When there is no POI in the re-determined POI search region, the controller 100 controls and processes to store the content alone, without tagging the POI to the content.

The controller 100 controls and processes to store POI information designated or input by the user through the POI manager 102 in the storage part 140, determines preference per POI type or per POI according to a pattern of use by the user, and stores the preference in the storage part 140. The controller 100 may determine the priority of the POIs according to the preference.

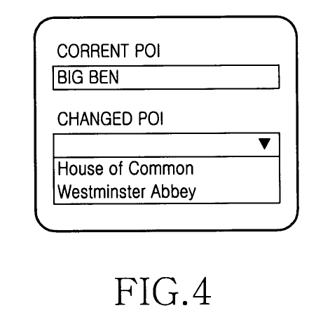

The controller 100 controls and processes to allow the user to change the POI tagged to the content according to the location information. For example, the controller 100 displays a screen showing the currently tagged POI and the changeable POIs as shown in FIG. 4, such that the user may change the tagged POI. In so doing, the controller 100 may display the POI tagged to the content and POIs with close location coordinates in the screen. The order of the displayed POIs may be determined based on the user's preference. When the POI tagged to a particular content is selected in the POI search region by considering both the speed and the direction of the movement, the user may set the POIs in the POI search region based on only the movement speed to the changeable POIs. The changeable POIs may differ from the POIs searched to tag the POI to the corresponding content.

The location information receiver 110 obtains and provides location information indicating the location of the portable terminal, i.e. location coordinates, to the controller 100. The location information may be acquired using a power of the portable terminal, an arrival time difference of propagation, a propagation receive angle of the antenna, and a Global Positioning System (GPS). The location information receiver 110 determines the speed and the direction of the traveling portable terminal using periodically acquired location information, and provides the determined speed and direction to the controller 100.

The search region determiner 120 receives the location coordinates of the terminal from the controller 100, and determines a POI search region based on the location coordinates according to a first radius preset. When the controller 100 requests to re-determine the POI search region, the search region determiner 120 determines the POI search region by considering the speed and the direction of the traveling portable terminal. When the portable terminal is traveling at the speed below a threshold, the search region determiner 120 determines the POI search region using a second radius preset. When the portable terminal is traveling at the speed over the threshold, the search region determiner 120 may determine the POI search region using a third radius preset. Herein, the first radius is smaller than the second radius, and the second radius is smaller than the third radius. In an embodiment, the search region determiner 120 may determine an area corresponding to a certain angle based on the movement direction of the portable terminal, as the search region, rather than determining the search region as the whole circular area with the radius based on the location coordinates of the terminal.

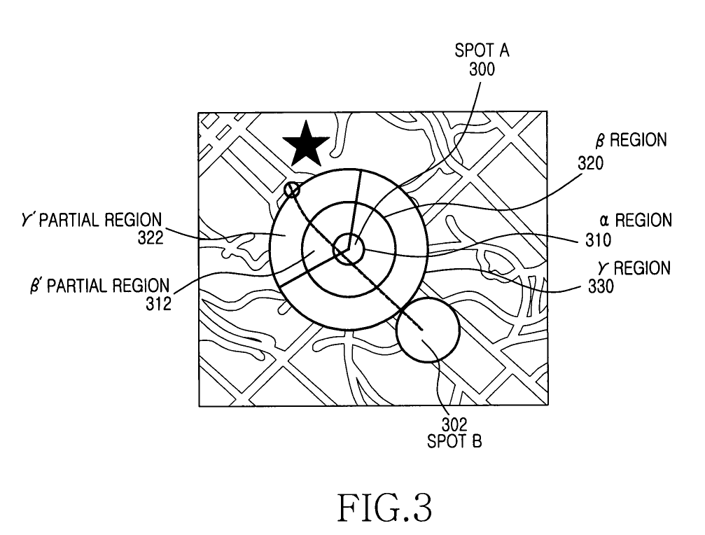

For example, when the portable terminal is positioned at the A spot 300, the search region determiner 120 may determine the search region as a 310 according to the preset radius as shown in FIG. 3. Next, when the portable terminal is moving at a low speed, the search region determiner 120 may determine the POI search region as β 320. When the portable terminal is moving at a high speed, the search region determiner 120 may determine the search region as γ 330. By confirming that the portable terminal is moving northwest, the search region determiner 120 may determine the POI search region to only β′ 312 or γ′ 322 corresponding to the northwest portion in the POI search region β 320 or γ 330 determined based on the movement speed.

The content generator 130 generates and provides contents such as memo, picture, video, SMS, and call, to the controller 100 under the control of the user.

The storage part 140 stores programs and data for the operations of the portable terminal. The storage part 140 includes the POI storage 150, the content storage 160, and the preference DB 170.

The POI storage 150 contains a user POI DB 152, a tourist attraction POI DB 154, and a general POI DB 156. The user POI DB 152 is POI information designated or input by the user, the tourist attraction DB 154 is POI information relating to well-known tourist attractions, and the general POI DB 156 is POI information related to the general geographical features and place names in the vicinity. For example, the user POI DB 154 may indicate names and location information of user's personal regions or features such as home, office, and practice room, and the tourist attraction DB 154 indicates names and location information of famous sites or features such as Eiffel Tower, Independence Gate, and Namsan. The general POI DB 156 indicates names and location information of regions or features such as restaurant, gas station, theatre, and park. The general POI DB 156 may indicate detailed category information for each POI. For example, when the POI ‘place’ is a Korean restaurant, its detailed category information may represent ‘restaurant, Korean dishes’. Herein, the user POI DB 152, the tourist attraction POD DB 154, and the general POI DB 156 may be updated by the user.

The content storage 160 stores the contents provided from the controller 100. The content storage 160 includes a location based DB 162 for storing the POI information mapped to the content, the content type, and the content creation time.

The preference DB 170 stores the preference per POI type or per POI according to the pattern of use by the user. The preference DB 170 stores and manages the preference according to the detailed category of the POI. For example, the preference DB 170 may specify which one of the restaurant, the gas station, the theatre, and the park the user prefers, and which one of the Japanese food, the Korean food, the Western food, and the flour based food the user prefers for the restaurant. When tagging is requested to use the general POI of the POIs stored to the POI storage 150, the general POI may have the tagging priority according to the value reflected to the preference DB 170.

Although it is not depicted in FIG. 1, the speed and the direction of the movement may be acquired by receiving data from an additional device such as a pedometer.

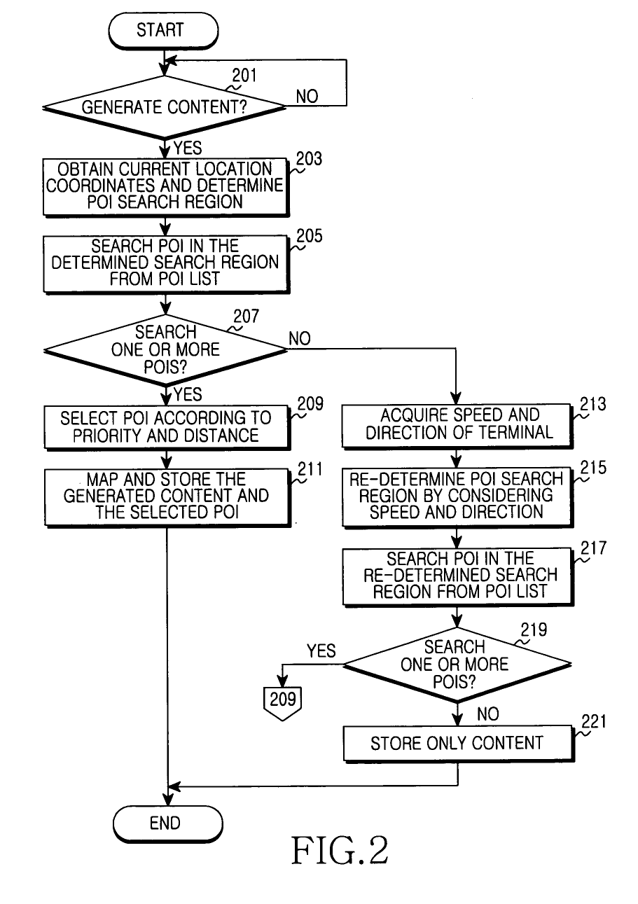

FIG. 2 illustrates a process for tagging the POI to the content in the portable terminal according to an embodiment of the present invention.

When the content is created in block 201, the portable terminal obtains the current location coordinates and determines the POI search region based on the location coordinates in block 203. For example, when the portable terminal is positioned at the A spot 300, the portable terminal may determine the search region as the α 310 according to the preset radius as shown in FIG. 3.

The portable terminal searches for POIs present in the determined POI search region among the POIs stored to the storage part 140 in block 205, and determines whether one or more POIs are found in block 207. That is, the portable terminal determines whether one or more POIs in the POI search region are found from POIs stored to the user POI DB 152, the tourist attraction POI DB 154, and the general POI DB 156.

When detecting one or more POIs, the portable terminal selects one of them according to the priority and the distance in block 209. More specifically, when one or more POIs are found from each of the user POI DB 152, the tourist attraction POI DB 154, and the general POI DB 156, the portable terminal selects one POI type based on the priority of the POI types. For example, when the priority of the POI types is the user POI>the tourist attraction POI>the general POI, the portable terminal selects only the POIs belonging to the general user POI among the searched POIs. Herein, the priority may be set and changed directly by the user, and may be set and changed by the preference based on the user's pattern of use. Next, the portable terminal may select the POI closest to the portable terminal among the selected POIs. At this time, when two or more POIs are closest to the portable terminal, the POI may be selected based on the preference stored to the preference DB 170.

Upon selecting the POI, the portable terminal maps and stores the created content and the selected POI in block 211 and then finishes this process.

When not finding one or more POIs, the portable terminal obtains the speed and the direction of the traveling terminal in block 213 and re-determines the POI search region by considering the speed and the direction in block 215. For instance, when the portable terminal travels from the B spot 302 to the A spot 300 and its movement speed is lower than the threshold, the search region determiner 120 may determine the POI search region as β 320. When the movement speed is higher than the threshold, the portable terminal may determine the POI search region to γ 330. By confirming that the portable terminal travels northwest, the portable terminal may determine the POI search region as only the partial region β′ 312 or γ′ 322 corresponding to the northwest portion of the POI search region β 320 or γ 330 determined based on the movement speed.

Upon re-determining the POI search region, the portable terminal searches POIs in the re-determined POI search region among the POIs stored to the storage part 140 in block 217, and determines whether one or more POIs are found in block 219.

When detecting one or more POIs, the portable terminal goes to block 209 to repeat the subsequent operation. By contrast, when not detecting one or more POIs, the portable terminal stores the generated content alone in block 221 and then finishes this process.

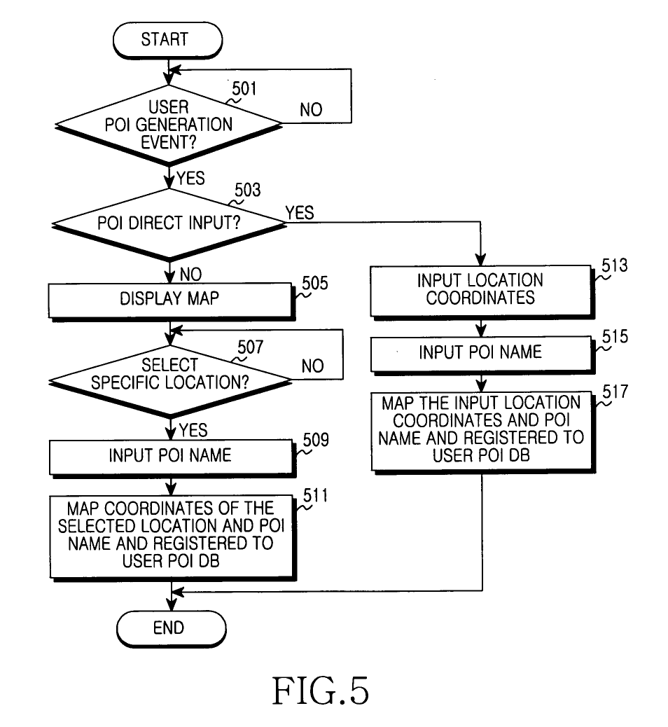

FIG. 5 illustrates a process for generating a user specific POI in the portable terminal according to an embodiment of the present invention.

When a user POI generation event takes place in block 501, the portable terminal examines whether a POI direct input menu is selected in block 503.

When the POI direct input menu is not selected, the portable terminal displays the map in block 505 and determines whether the user selects a specific location in block 507. Herein, the portable terminal may display the map of a specific location according to the user's manipulation. When the user selects a specific location, the portable terminal receives the POI name from the user in block 509, maps and registers the coordinates of the selected location and the POI map to the user POI DB 152 in block 511, and then finishes this process.

By contrast, when the POI direct input menu is selected, the portable terminal receives the location coordinates from the user in block 513 and receives the POI name in block 515. Next, the portable terminal maps and registers the input location coordinates and the POI name to the user POI DB 152 in block 517, and finishes this process. Herein, the user manually inputs the location coordinates. In an embodiment, when the user inputs address information, the portable terminal may acquire the location coordinates from the address information.

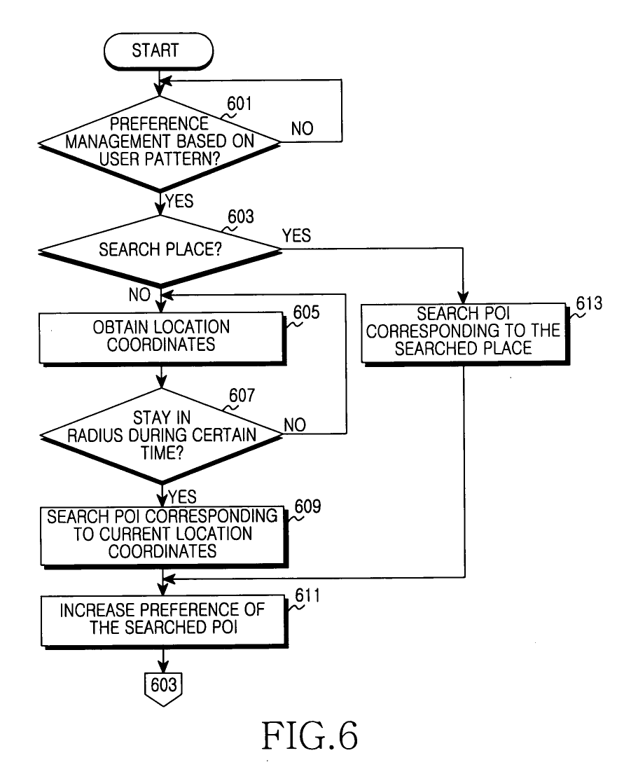

FIG. 6 illustrates a process for managing the preference of the POI in the portable terminal according to an embodiment of the present invention.

When the preference management function based on the user pattern is set in block 601, the portable terminal determines whether the user searches a specific place in block 603. For instance, the specific place is searched by selecting the specific place on the map, enlarging a specific location on the map, or searching information related to the specific place using a web service.

When the user searches the specific place, the portable terminal searches the POI corresponding to the searched specific place from the POI storage 150 in block 613. Not finding the same POI as the location coordinates of the specific place, the portable terminal may search the POI of the location coordinates closest to the location coordinates of the specific place. Next, the portable terminal increases the preference of the searched POI in block 611 and returns to block 603. The portable terminal may increase the preference of not only the searched POI but also the detailed category of the searched POI.

When the user does not search the specific place, the portable terminal periodically acquires the current location coordinates in block 605. In block 607, the portable terminal determines whether it stays in the preset radius for a certain time, based on the location coordinates periodically acquired.

When determining that the portable terminal is not in the preset radius for the certain time, the portable terminal goes back to block 605. When determining that it stays in the preset radius for the certain time, the portable terminal searches the POI corresponding to the current location coordinates from the POI storage 150 in block 609. In so doing, when not finding the same POI as the current location coordinates, the portable terminal may search the POI of the location coordinates closet to the current location coordinates. Next, the portable terminal increases the preference of the searched POI in block 611 and returns to block 603. The portable terminal may increase the preference of not only the searched POI but also the detailed category of the searched POI.

As set forth above, the POIs are managed as tourist attraction POIs, general POIs, and user specific POIs. The POI is determined based on the speed and the direction of movement as well as the location of the terminal, and the POI is automatically tagged to the UCC. Therefore, the POI may be tagged without adding a separate device, the POI involving the content may be determined more efficiently, and the contents may be easily managed.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A content tagging method in a portable terminal, comprising:
when creating a content, determining a search region using current location information;
searching a Point of Interest (POI) corresponding to the search region from a stored POI list; and
tagging the searched POI to the content.

2. The content tagging method of claim 1, wherein the search region is determined using at least one of the current location information, a movement speed, and a movement direction of the portable terminal.

3. The content tagging method of claim 2, wherein the search region is determined as a region corresponding to a first radius based on the current location information.

4. The content tagging method of claim 2, wherein, when the movement speed is lower than a threshold, the search region is determined as a region corresponding to a second radius based on the current location information, and when the movement speed is greater than the threshold, the search region is determined as a region corresponding to a third radius based on the current location information,
wherein the second radius is smaller than the third radius.

5. The content tagging method of claim 2, wherein the search region is determined as a partial region corresponding to the movement direction of the portable terminal, in a region corresponding to a preset radius based on the current location.

6. The content tagging method of claim 1, wherein the stored POI list comprises at least one of a POI list registered by a user, a tourist attraction POI list, and a POI list of general geographic features and place names.

7. The content tagging method of claim 1, further comprising:
when a plurality of POIs from the stored POI list exist in the search region, selecting one POI based on a priority and a distance of each POI in the search region.

8. The content tagging method of claim 7, wherein the priority of the POI is changed and set according to a pattern of use by the user.

9. The content tagging method of claim 8, wherein the priority of the POI corresponding to a specific place is changed and set according to whether the specific place is searched or whether the portable terminal stays in the specific place over a certain time.

10. The content tagging method of claim 1, wherein the POI tagged to the content is changeable by the user.

11. A content tagging apparatus in a portable terminal, comprising:
a content generator configured to create a content;
a location information receiver configured to periodically obtain location information of the portable terminal;
a region determiner configured to determine a search region using the current location information;
a storage part configured to store a POI list; and
a Point of Interest (POI) manager configured to search a POI corresponding to the search region from the stored POI list, and tagging the searched POI to the content.

12. The content tagging apparatus of claim 11, wherein the region determiner determines the search region using at least one of the current location information, a movement speed, and a movement direction of the portable terminal.

13. The content tagging apparatus of claim 12, wherein the region determiner determines the search region as a region corresponding to a first radius based on the current location information.

14. The content tagging apparatus of claim 12, wherein, when the movement speed is lower than a threshold, the region determiner determines the search region as a region corresponding to a second radius based on the current location information, and when the movement speed is greater than the threshold, the region determiner determines the search region as a region corresponding to a third radius based on the current location information,
wherein the second radius is smaller than the third radius.

15. The content tagging apparatus of claim 12, wherein the region determiner determines the search region as a partial region corresponding to the movement direction of the portable terminal, in a region corresponding to a preset radius based on the current location.

16. The content tagging apparatus of claim 11, wherein the storage part stores at least one of a POI list registered by a user, a tourist attraction POI list, and a POI list of general geographic features and place names in vicinity.

17. The content tagging apparatus of claim 11, wherein, when a plurality of POIs from the stored POI list exist in the search region, the POI manager selects one POI based on a priority and a distance of each POI in the search region.

18. The content tagging apparatus of claim 17, wherein the POI manager changes and sets the priority of the POI according to a pattern of use by the user.

19. The content tagging apparatus of claim 18, wherein the POI manager changes and sets the priority of the POI corresponding to a specific place according to whether the specific place is searched or whether the portable terminal stays in the specific place over a certain time.

20. The content tagging apparatus of claim 11, wherein the POI tagged to the content is changeable by the user.
